(19) United States
(12) Patent Application Publication
(10) Pub. No.: US 2024/0402350 A1
(43) Pub. Date: Dec. 5, 2024

(54) EXPANDED STATE SPACE REPRESENTATION (SSR) GENERATION FROM MEASUREMENT INFORMATION AND INITIAL SSR

(71) Applicant: QUALCOMM Incorporated, San Diego, CA (US)

(72) Inventors: Yuxiang PENG, Sunnyvale, CA (US); Ning LUO, Cupertino, CA (US); Yuhua HU, Sunnyvale, CA (US)

(21) Appl. No.: 18/328,674

(22) Filed: Jun. 2, 2023

(51) Int. Cl. G01S 19/07

(52) U.S. Cl. CPC G01S 19/072; G01S 19/073

(57) ABSTRACT

In some implementations, one or more devices may obtain measurement information for an epoch, the measurement information indicative of a pseudorange measurement, a carrier phase measurement, and a doppler measurement performed by a reference global navigation satellite system (GNSS) receiver of radio frequency (RF) signals transmitted by a plurality of GNSS satellites. The device(s) may obtain initial state-space representation (SSR) data comprising orbit correction, clock correction, and code bias information for the epoch. The device(s) may determine ionospheric correction data for the epoch based on the measurement information and the initial SSR data. The device(s) may determine tropospheric correction data for the epoch based on the determined ionospheric correction data, the measurement information, and the initial SSR data. The device(s) may provide the expanded SSR data, wherein the expanded SSR data includes the ionospheric correction data and the tropospheric correction data.

### BACKGROUND

### 1. Field of Disclosure

The present disclosure relates generally to the field of satellite-based positioning.

### 2. Description of Related Art

Global Navigation Satellite Systems (GNSS) positioning of mobile devices (e.g., consumer electronics, vehicles, assets, drones, etc.) can provide accurate positioning of a mobile device comprising a GNSS receiver. Traditional GNSS positioning provides an accuracy on the order of a few meters, and more precise GNSS-based techniques can provide sub-meter accuracy. Precise Point Positioning (PPP) and Real Time Kinematic (RTK) are two types of GNSS-based positioning techniques that provide more precision. These techniques use additional correction information to achieve higher precision than traditional GNSS positioning. However, only a subset of this correction information can be obtained for free. Additional correction information typically may be obtained at a cost.

### BRIEF SUMMARY

An example method of providing expanded state-space representation (SSR) data for global navigation satellite system (GNSS)-based positioning, according to this disclosure, may comprise obtaining measurement information for an epoch, the measurement information indicative of a pseudorange measurement, a carrier phase measurement, and a doppler measurement performed by a reference GNSS receiver of radio frequency (RF) signals transmitted by a plurality of GNSS satellites. The method also may comprise obtaining initial SSR data comprising orbit correction, clock correction, and code bias information for the epoch. The method also may comprise determining ionospheric correction data for the epoch based on the measurement information and the initial SSR data. The method also may comprise determining tropospheric correction data for the epoch based on the determined ionospheric correction data, the measurement information, and the initial SSR data. The method also may comprise providing the expanded SSR data, wherein the expanded SSR data includes the ionospheric correction data and the tropospheric correction data.

An example device for providing expanded state-space representation (SSR) data for global navigation satellite system (GNSS)-based positioning, according to this disclosure, may comprise one or more transceivers, one or more memories, one or more processors communicatively coupled with the one or more transceivers and the one or more memories, wherein the one or more processors are configured to obtain measurement information for an epoch, the measurement information indicative of a pseudorange measurement, a carrier phase measurement, and a doppler measurement performed by a reference GNSS receiver of radio frequency (RF) signals transmitted by a plurality of GNSS satellites. The one or more processors further may be configured to obtain initial SSR data comprising orbit correction, clock correction, and code bias information for the epoch. The one or more processors further may be configured to determine ionospheric correction data for the epoch based on the measurement information and the initial SSR data. The one or more processors further may be configured to determine tropospheric correction data for the epoch based on the determined ionospheric correction data, the measurement information, and the initial SSR data. The one or more processors further may be configured to provide the expanded SSR data, wherein the expanded SSR data includes the ionospheric correction data and the tropospheric correction data.

An example apparatus for providing expanded state-space representation (SSR) data for global navigation satellite system (GNSS)-based positioning, according to this disclosure, may comprise means for obtaining measurement information for an epoch, the measurement information indicative of a pseudorange measurement, a carrier phase measurement, and a doppler measurement performed by a reference GNSS receiver of radio frequency (RF) signals transmitted by a plurality of GNSS satellites. The apparatus further may comprise means for obtaining initial SSR data comprising orbit correction, clock correction, and code bias information for the epoch. The apparatus further may comprise means for determining ionospheric correction data for the epoch based on the measurement information and the initial SSR data. The apparatus further may comprise means for determining tropospheric correction data for the epoch based on the determined ionospheric correction data, the measurement information, and the initial SSR data. The apparatus further may comprise means for providing the expanded SSR data, wherein the expanded SSR data includes the ionospheric correction data and the tropospheric correction data.

According to this disclosure, an example non-transitory computer-readable medium stores instructions for providing expanded state-space representation (SSR) data for global navigation satellite system (GNSS)-based positioning, the instructions comprising code for obtaining measurement information for an epoch, the measurement information indicative of a pseudorange measurement, a carrier phase measurement, and a doppler measurement performed by a reference GNSS receiver of radio frequency (RF) signals transmitted by a plurality of GNSS satellites. The instructions further may comprise code for obtaining initial SSR data comprising orbit correction, clock correction, and code bias information for the epoch. The instructions further may comprise code for determining ionospheric correction data for the epoch based on the measurement information and the initial SSR data. The instructions further may comprise code for determining tropospheric correction data for the epoch based on the determined ionospheric correction data, the measurement information, and the initial SSR data. The instructions further may comprise code for providing the expanded SSR data, wherein the expanded SSR data includes the ionospheric correction data and the tropospheric correction data.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a Global Navigation Satellite System (GNSS), according to an embodiment.

FIG. 2 is a block diagram of a Precise Point Positioning (PPP) Precise Positioning Engine (PPE), according to an embodiment.

FIG. 3 is a block diagram illustrating an example Real Time Kinematic (RTK) positioning scheme, according to aspects of the disclosure.

FIG. 4 is an illustration of a table showing the various data fields of state space representation (SSR) data, according to some embodiments.

FIG. 5 is an illustration of a graph showing an example of pseudorange (PR) total electron content (TEC) smoothing, according to some embodiments.

FIGS. 6A and 6B are diagrams of scenarios that illustrate ways in which expanded SSR data may be determined and propagated, according to some embodiments.

FIG. 7 is a flow diagram illustrating an example method providing expanded SSR data for GNSS-based positioning, according to aspects of the disclosure.

FIG. 8 is a block diagram of an embodiment of a GNSS device.

FIG. 9 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described concerning the accompanying drawings, which form a part hereof. While particular examples, in which one or more aspects of the disclosure may be implemented, are described below, other examples may be used, and various modifications may be made, without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “User Equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. According to some embodiments, a mobile device and/or UE may be used to communicate over a wireless communications network. A UE may be mobile or may (e.g., at certain times) be stationary, and may communicate with a Radio Access Network (RAN). As used herein, the term UE may be referred to interchangeably as an Access Terminal (AT), a client device, a wireless device, a subscriber device, a subscriber terminal, a subscriber station, a user terminal (UT), a mobile device, a mobile terminal, a mobile station, or variations thereof. Generally, UEs can communicate with a core network via a RAN, and through the core network, the UEs can be connected with external networks (such as the Internet) and with other UEs. Other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 standard, etc.), and so on.

A “space vehicle” (SV) as referred to herein, relates to an object that is capable of transmitting signals to receivers on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

As previously noted, GNSS-based positioning techniques such as Precise Point Positioning (PPP) and Real Time Kinematic (RTK) can provide high precision-sometimes centimeter-level accuracy. To provide such high-precision positioning at a target GNSS device, such techniques apply error correction to GNSS measurements performed at the device. State space representation (SSR), which can include up to eight elements of error correction, is one format in which such error correction may be communicated. However, only a subset of this correction information (referred to herein as “publicly available” or “initial” SSR) can be obtained for free. Additional correction information typically may be obtained at a cost. To address these and other concerns, embodiments described herein provide for determining expanded SSR data (e.g., that would otherwise come at a cost) based on initial SSR and GNSS measurement data from a reference GNSS receiver.

Various aspects relate generally to the use of state space representation (SSR) data to help enable high-accuracy positioning of a device using techniques such as precise point positioning (PPP) or real-time kinematic (RTK) positioning. Some aspects more specifically relate to using initial SSR data fields and measurement information to derive additional (“expanded”) SSR data fields. In some examples, a server or other device may obtain publicly-available initial SSR data and measurement information from a reference device to determine expanded SSR data for a target device. The initial SSR data may comprise orbit, clock, and code bias correction information, and the expanded SSR data may comprise tropospheric correction data and ionospheric correction data. In some embodiments, the expanded SSR data may be determined and provided to the target device in response to a request for the expanded SSR data from the target device. By determining expanded SSR data in this manner, embodiments can enable highly-accurate positioning observations with a relatively low convergence time (e.g., relative to using only the publicly-available initial SSR data) without the need for a separate SSR service. Moreover, embodiments can enable the use of SSR for RTK positioning, which can be more efficient than using the observation-space representation (OSR) data traditionally used in RTK.

Embodiments for determining expanded SSR data are provided in detail hereafter, following a review of applicable technology.

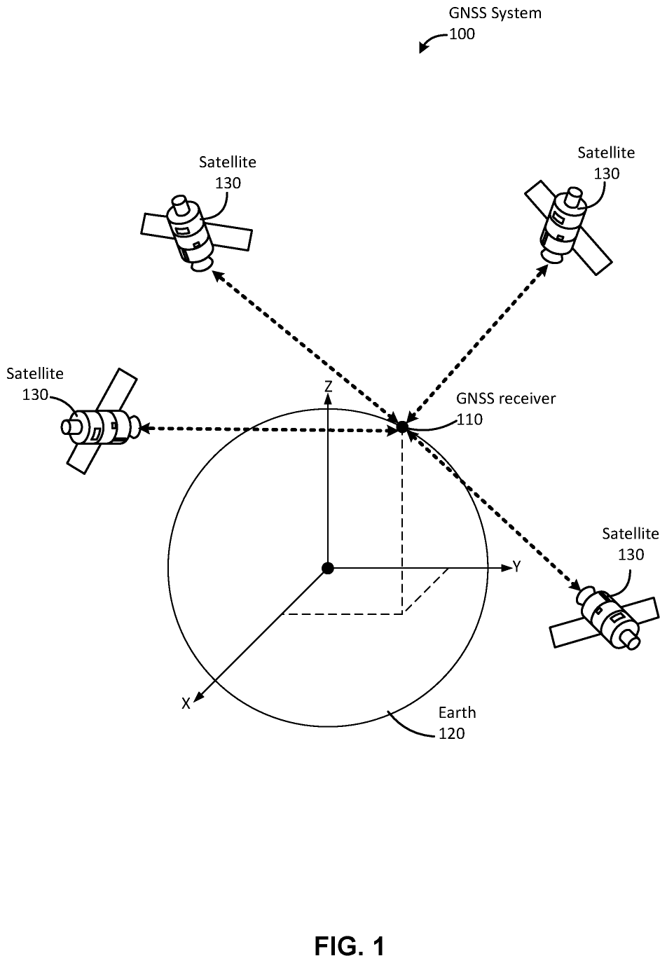

FIG. 1 is a simplified diagram of a GNSS system 100, provided to illustrate how GNSS is generally used to determine an accurate location of a GNSS receiver 110 on Earth 120. Put generally, the GNSS system 100 enables an accurate GNSS position fix of the GNSS receiver 110, which receives RF signals from GNSS satellites 130 (also known as GNSS “satellite vehicles” or “SVs”) from one or more GNSS constellations. The types of GNSS receiver 110 used may vary, depending on the application. In some embodiments, for instance, the GNSS receiver 110 may comprise a standalone device or component incorporated into another device. In some embodiments, the GNSS receiver 110 may be integrated into industrial or commercial equipment, such as survey equipment, Internet of Things (IoT) devices, etc.

It will be understood that the diagram provided in FIG. 1 is greatly simplified. In practice, there may be dozens of satellites 130 and a given GNSS constellation, and there are many different types of GNSS systems. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, the determination of the position of a GNSS receiver 110 in three dimensions may rely on a determination of the distance between the GNSS receiver 110 and four or more satellites 130. As illustrated, 3D coordinates may be based on a coordinate system (e.g., XYZ coordinates; latitude, longitude, and altitude; etc.) centered at the earth's center of mass. A distance between each satellite 130 and the GNSS receiver 110 may be determined using precise measurements made by the GNSS receiver 110 of a difference in time from when an RF signal is transmitted from the respective satellite 130 to when it is received at the GNSS receiver 110. To help ensure accuracy, not only does the GNSS receiver 110 need to make an accurate determination of when the respective signal from each satellite 130 is received, but many additional factors need to be considered and accounted for. These factors include, for example, clock differences at the GNSS receiver 110 and satellite 130 (e.g., clock bias), a precise location of each satellite 130 at the time of transmission (e.g., as determined by the broadcast ephemeris), the impact of atmospheric distortion (e.g., ionospheric and tropospheric delays), and the like.

To perform a traditional GNSS position fix, the GNSS receiver 110 can use code-based positioning to determine its distance to each satellite 130 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 130, the GNSS receiver 110 can then determine a position fix for its location. This position fix may be determined, for example, by a Standalone Positioning Engine (SPE) executed by one or more processors of the GNSS receiver 110. However, code-based positioning is relatively inaccurate and, without error correction, and is subject to many of the previously described errors. Even so, code-based GNSS positioning can provide a positioning accuracy for the GNSS receiver 110 on the order of meters.

More accurate carrier-based ranging is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric errors sources) in the carrier-based ranging of satellites 130 observed by the GNSS receiver 110 can be mitigated or canceled based on similar carrier-based ranging of the satellites 130 using a highly accurate GNSS receiver at the base station at a known location. These measurements and the base station's location can be provided to the GNSS receiver 110 for error correction. This position fix may be determined, for example, by a Precise Positioning Engine (PPE) executed by one or more processors of the GNSS receiver 110. More specifically, in addition to the information provided to an SPE, the PPE may use base station GNSS measurement information, and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 1, the satellites 130 may be members of a single satellite constellation, i.e., a group of satellites that are part of a GNSS system, e.g . . . controlled by a common entity such as a government, and orbiting in complementary orbits to facilitate determining positions of entities around the world. One or more of the satellites 130 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

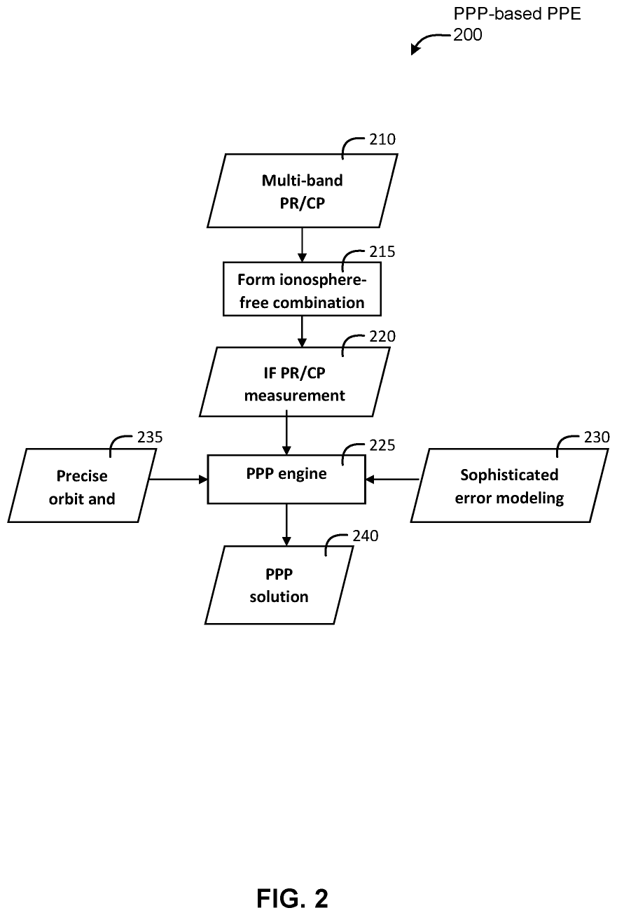

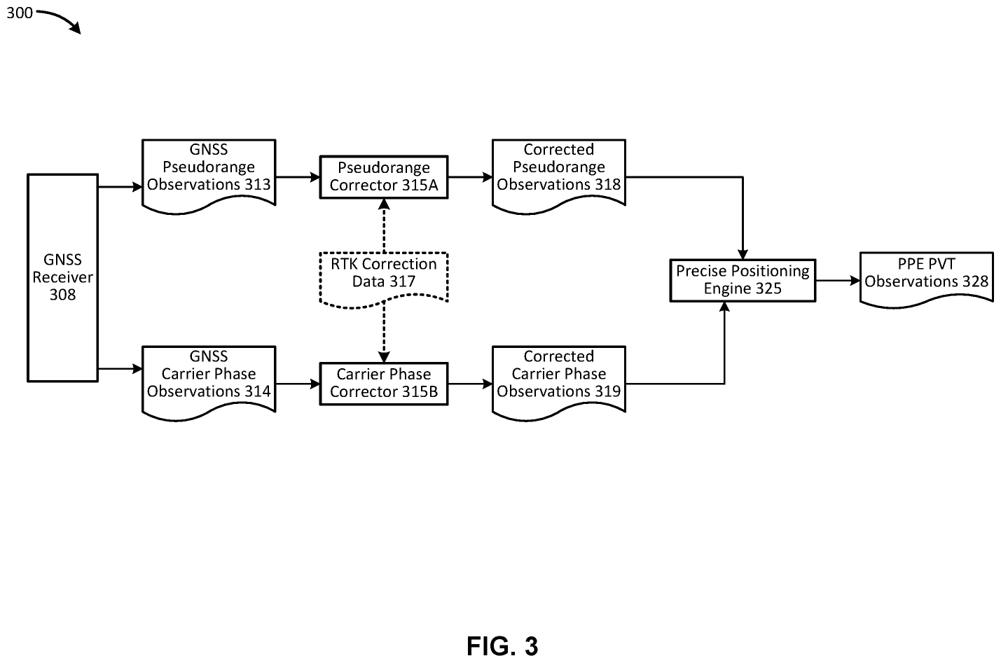

As previously noted, high-accuracy, or “precise,” GNSS-based positioning (e.g., PPP or RTK positioning) utilize error correction provided by an error correction service. FIGS. 2 and 3 generally illustrate how such correction may be utilized in PPP and RTK.

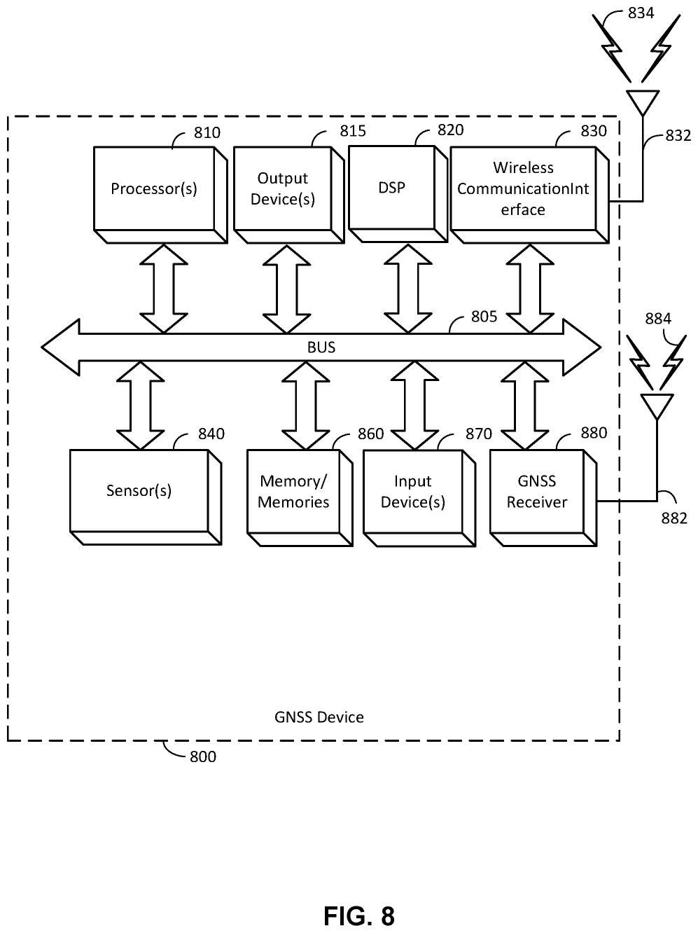

FIG. 2 is a block diagram of a PPP-based PPE 200, which may be used to determine an accurate PPP-based position. The blocks in FIG. 2 comprise data and logical processes used by a PPE to perform PPP-based positioning of a GNSS receiver (e.g., the GNSS receiver 110 of FIG. 1). In some embodiments, the various blocks in FIG. 2 may be implemented by software and/or hardware components of a positioning engine, which may be integrated into the mobile device for which positioning is determined. (Example components of a mobile device are shown in FIG. 8, which is described in detail hereafter.).

At block 210, the GNSS receiver obtains multi-band pseudo-range (PR) and carrier phase (CP) measurement of signals from each of the plurality of satellites (e.g., satellites 130 of FIG. 1). PR and CP measurements may correspond with code-based and carrier-based measurements, respectively, as previously described. To make a multi-band measurement (a measurement of signals using two or more frequencies transmitted by a satellite), embodiments may use a multi-band GNSS receiver (e.g., a dual-band receiver, tri-band receiver, etc.) capable of receiving a plurality of frequency bands. Some embodiments may use multi-constellation multi-frequency (MCMF) receivers capable of receiving multiple frequency bands on multiple constellations. Examples of different bands used for the multi-band PR/CP measurement at block 210 include L1/L5 for GPS, E1/E5A for GAL, and B1C/B2A for BDS. Other embodiments may use additional or alternative bands and/or GPS constellations.

At block 215, an ionosphere-free (IF) combination is formed. An ionosphere-free combination comprises a linear combination of code and/or carrier measurements that can eliminate first-order ionospheric effects from ionospheric refraction, which can increase the accuracy of the positioning solution. As shown by block 220, the ionosphere-free (IF) PR/CP measurement formed from the IF combination is provided to the PPP engine 225.

The sophisticated error modeling at block 230 comprises error modeling to mitigate inaccuracies based on various error sources. Standard PPP error mitigation includes error reduction techniques to reduce satellite different code bias (DCB), satellite phase windup-up, site displacement, and more. These errors may result in inaccuracies of several meters or more, and mitigation can be performed by a Kalman Filter (KF) (or Extended Kalman Filter (EKF)), which may estimate these errors/values.

The PPP engine 225 uses the IF PR/CP measurement (block 220), sophisticated error modeling (block 230), and precise orbit and clock (block 235) to conduct a KF estimation to provide the PPP solution at block 240. As a person of ordinary skill in the art will appreciate, a PPP engine can be implemented using an Extended Kalman Filter (EKF).

As noted, devices may utilize a PPE to provide high-precision positioning using PPP and/or RTK correction information. Both PPP and RTK have benefits and drawbacks. For RTK, which derives correction information from differential GNSS readings between a target device (or “rover station”) and one or more local base stations, benefits include simple error modeling computation and better performance on error canceling. The drawbacks of RTK, however, include the need for local or regional reference stations and a larger bandwidth requirement (relative to PPP). For PPP, which involves providing precise orbit/clock information to a target device (and optional ionosphere and troposphere correction for additional enhancement), benefits include a low bandwidth requirement (relative to RTK) and global coverage. Drawbacks of PPP include the need for complex error modeling computation.

FIG. 3 is a block diagram illustrating an example RTK positioning scheme 300, according to aspects of the disclosure. In some embodiments, the various blocks may be implemented by software and/or hardware components of a positioning engine, which may be integrated into the mobile device for which positioning is determined. (Example components of a mobile device are shown in FIG. 8, which is described in detail hereafter.)

According to positioning scheme 300, a GNSS receiver 308 measures GNSS signals to obtain GNSS pseudorange observations 313 and GNSS carrier phase observations 314. In various examples, the GNSS receiver 308 may correspond to GNSS receiver 110 of FIG. 1 and/or may be incorporated into a mobile or other device (e.g., a mobile device as described herein). Based on RTK correction data 317, a pseudorange corrector 315A corrects GNSS pseudorange observations 313 to obtain corrected pseudorange observations 318, and a carrier phase corrector 315B corrects GNSS carrier phase observations 314 to obtain corrected carrier phase observations 319. In various examples, the RTK correction data 317 may be representative of correction data provided by a correction service (e.g., RTK correction service). Based on corrected pseudorange observations 318 and corrected carrier phase observations 319, a precise positioning engine (PPE) 325 generates PPE position, velocity, and time (PVT) observations 328.

As noted with respect to FIGS. 2 and 3, high-precision PPE position determination (e.g., using PPP and/or RTK) for a GNSS device typically utilizes error correction received from a remote device (e.g., error correction service). Although PPP products may use state-space representation (SSR) format for error correction, conventionally, most PPE or RTK products use error correction in observation-space representation (OSR) format. OSR format provides a “lump sum” of error components that are represented in observation space. These components may include pseudorange. carrier phase, Doppler, and CN0 from multiple GNSS constellations, signals, satellites (SVs).

That said, more and more modern products are starting to accept or offer error correction in SSR format. This is because SSR format has several advantages, including utilizing a smaller communication bandwidth (less traffic), having a scalable frequency operation (no frequency dependency), being included in many standards evolutions (Radio Technical Commission for Maritime Services (RTCM), 3rd Generation Partnership Project (3GPP), international GNSS service (IGS)), and a portion of SSR data (orbit, clock, code bias) are available to the public, such as international GNSS service IGS SSR, BDS (Beudou) B2b (or B2b-PPP) correction.

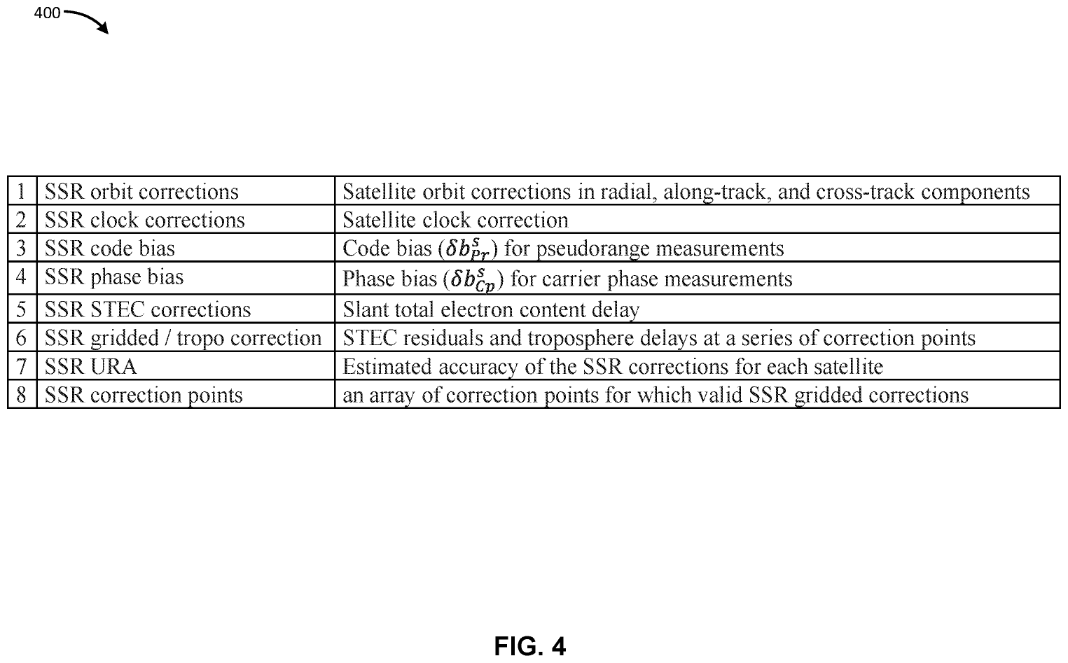

FIG. 4 is an illustration of Table 400, showing the various data fields of SSR data, according to some embodiments. Specifically, SSR data may include eight types of data, which may be referred to herein by “SSR” followed by the responded numeral in the first column of Table 400. Thus, SSR1 comprises satellite orbit corrections, SSR2 comprises deadline clock corrections, SSR3 comprises code bias (e.g., differential code bias (DCB)), SSR4 comprises phase bias, SSR5 comprises slants total electron content (STEC) delay correction (e.g., ionosphere delay correction), SSR6 (which may be referred to herein generally as tropospheric delay correction) comprises STEC residuals and tropospheric delays, SSR7 comprises an estimated accuracy value (e.g., user range accuracy (URA)) of other SSR data (e.g., SSR1-SSR6), and SSR8 comprises correction points for which valid SSR gridded corrections are applicable. In error correction, SSR may be provided as a vector with one or more of the data fields shown in Table 400, where each element of the vector represents a different data field.

Generally put, the more SSR elements that are used for positioning, the more accurate the positioning solution can be. For example, SSR1-SSR3 may be considered “standard” SSR for PPP solutions. Although this can result in increasing GNSS-based positioning accuracy from 5-10 m to roughly 2.5-5 m, the accuracy is case-dependent (e.g., based on conditions like current ionosphere error) and convergence time may be relatively long if only SSR1-SSR3 are used. The standard SSR elements (SSR1-SSR3) are broadcast to the public for free, allowing for free increased accuracy over traditional GNSS positioning. But many applications require higher accuracy and/or lower convergence times, in which case additional SSR elements are needed. According to traditional techniques, SSR data are obtained using a network of reference GNSS receivers distributed geographically over a coverage region. Because SSR1-SSR3 require relatively fewer receivers than SSR5-SSR6, this data may be obtained at a relatively low cost. However, according to these traditional techniques, obtaining SSR5-SSR6 using a relatively dense network of references GNSS receivers can be costly.

Embodiments herein address these and other issues by generating expanded SSR data based on the publicly-available standard SSR (SSR1-SSR3) (also referred to herein as “initial SSR”) and GNSS measurements from a reference GNSS receiver. As used herein, “expanded SSR” and variants thereof referred to SSR data comprising “non-standard” SSR, including one or more of SSR4-SSR8. Embodiments may be used to compile a complete set of SSR correction data (SSR1-SSR8) or high-precision PPE positioning. However, of particular interest are error correction for ionospheric delay, or “iono,” (SSR5) and tropospheric delay, or “tropo,” (SSR6), which, when corrected, can provide significant improvements in accuracy. This expanded SSR, therefore, can be provided to a device for PPE positioning (e.g., via a cellular network) without the relatively high cost for doing so associated with traditional SSR data generation techniques.

Further, this solution may be combined with an SSR-to-OSR conversion techniques to enable PPE positioning for RTK and/or other PPE solutions that traditionally use OSR data, enabling more widespread and lower-cost high-precision positioning. Benefits of using SSR rather than OSR may include lower traffic RTK service (additional information regarding this aspect will be provided hereafter), improved PPP performance from standard SSR (slow convergence, meter-level accuracy) into expanded SSR (fast convergence, cm-level accuracy), enhancing existing PPP-RTK performance with scalable reference stations (e.g., improved quality over a geographical region by introducing additional reference GNSS receivers), largely reducing reference station multipath and noise impact compared to OSR format service method, among other things.

As noted, expanded SSR data can be generated from initial SSR data (SSR1-SSR3) as well as GNSS measurements from a reference GNSS receiver. (Additional information regarding how GNSS measurements may be obtained is provided hereafter.) GNSS measurements from the reference GNSS receiver may include pseudorange (PR), carrier phase (CP), and Doppler (DPL)) measurements of RF signals transmitted by each of one or more GNSS SVs. These measurements for a given SV, s, may be represented by the following equations:

$${PR}^{s} = \vert {\vec{r}}^{s} - {\vec{r}}_{r} \vert + c [ {dt}_{r} ( {t}_{r} ) - {dT}_{b}^{s} ( {t}^{s} ) ] + {I}^{s} + {T}^{s} + δ {b}_{Pr}^{s} + {dPR}^{s} + {ϵ}_{PR} , \qquad ( Eqn . 1 )$$

$${CP}^{s} = \vert {\vec{r}}^{s} - {\vec{r}}_{r} \vert + c [ {dt}_{r} ( {t}_{r} ) - {dT}_{b}^{s} ( {t}^{s} ) ] - {I}^{s} + {T}^{s} + {FCB}^{s} + {dCP}^{s} + λ \cdot {N}^{s} + {ϵ}_{CP} , \qquad ( Eqn . 2 )$$

$${DPL}^{s} = - \{ {v}_{r}^{s} \cdot \frac{{r}_{r}^{s}}{\vert {r}_{r}^{s} \vert} + c [ d {\dot{t}}_{r} ( {t}_{r} ) - d {\dot{T}}_{b}^{s} ( {t}^{s} ) ] + {d}_{sav}^{\dot{s}} \} / λ + {ϵ}_{DPL} , \qquad ( Eqn . 3 )$$

where PR^{s} and CP^{s} may be represented in meters (m) and DPL^{s} may be represented in Hertz (Hz). With respect to the various terms in Eqns. 1-3, \vec{r}^{s} is the SV position, \vec{r}ᵣ is the reference GNSS receiver position, c is the speed of light in a vacuum, dtᵣ(tᵣ) is the receiver clock bias (which is typically given a value of zero, given that SSR data represents a “virtual receiver”), dT_{b}^{s}(t^{s}) is the SV clock bias, is the I^{s} ionospheric delay, T^{s} is the tropospheric delay, Sb_{Pr}^{s}, is the pseudorange code bias (corresponding to SSR3, see Table 400 of FIG. 4), ϵ_{PR} is the pseudorange noise (e.g., gaussian and/or non-gaussian/stochastic noise), FCB^{s} is the fractional cycle bias (considered to be the major source of and interchangeable with carrier phase bias, corresponding to SSR4), λ is the signal wavelength, N^{s} is the carrier phase integer ambiguity, ϵ_{CP} is the carrier phase noise, vᵣ^{s} is the SV position vector, rᵣ^{s} is the SV velocity vector, and ϵ_{DPL} is the Doppler noise. dPRS and dCPS are correction terms that can be determined as follows:

$${dPR}^{s} = {d}_{s a c}^{s} - {d}_{p c o}^{T} + {d}_{p c v} ( E l ) - {d}_{disp}^{T} + {d}_{rel}^{T} , \qquad ( Eqn . 4 )$$

$$dC {P}^{s} = {dPR}^{s} + λ {ϕ}_{pw} , \qquad ( Eqn . 5 )$$

where d_{sac}^{s} represents the Sagnac effect (compensation for Earth rotation effects to SV position and velocity), d_{pco}^{T} is the SV antenna phase center offset, d_{pcv}(El) is the SV antenna phase center variation, d_{disp} represents the site displacement effect, dᵣₑₗ^{T} represents relativity effects, and λϕ_{pw} is the SV phase-windup.

In view of Eqns. 1-5 above, the determination of expanded SSR data may be summarized as indicated in Table 1:

TABLE 1

| | |
|---|---|
| Known | Receiving time, \vec{r}ᵣ, λ, c |
| Computable | \vec{r}^{s}, d_{disp}^{T}, I^{s} *, T^{s}, d_{sac}^{s}, d_{pco}^{T}, dᵣₑₗ^{T}, ϕ_{pw} |
| Correction needed | \vec{r}^{s}, dT_{b}^{s}(t^{s}), I^{s}, T^{s}, δb_{Pr}^{s}, FCB^{s} |
| Negligible | dtᵣ(tᵣ), ϵ_{PR}, ϵ_{CP}, ϵ_{DPL}, N^{s}, d_{pcv} (El) |
| Assisted data | Eph, ERP, Earth nutation, ANTEX |

In reference to Table 1, “known” terms are those that are known at the time measurements are taken, “computable” terms are those that can be determined based on available information including publicly-available initial SSR, “correction needed” terms represent terms to be determined in the determination of expanded SSR data, “negligible” terms are those that have such a little impact that may be ignored for purposes of SSR determination, and “assisted data” are the types of data used for the determination of expanded SSR.

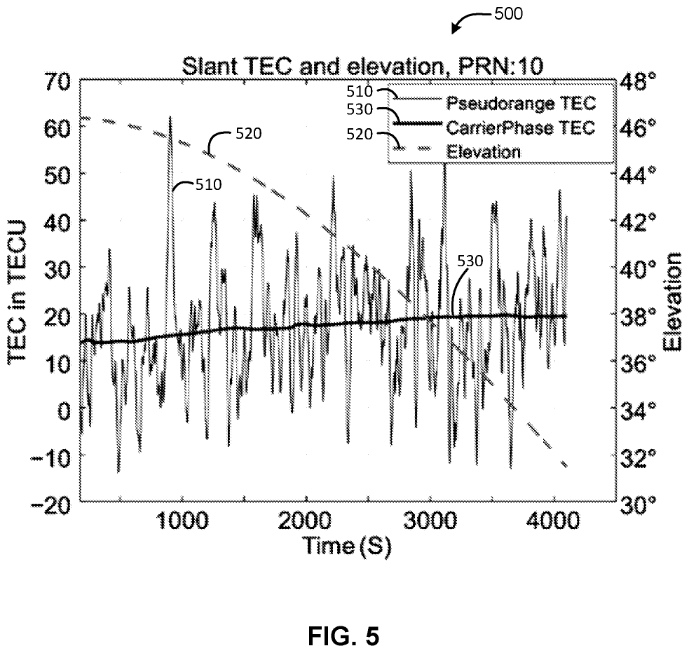

STEC from different GNSS SVs are spatially correlated. (Vertical ionospheric delay may be approximately the same for different GNSS SVs.) So SSR5 may be applicable to GNSS receiver is within a geographical region. To determine STEC, embodiments may utilize multi-frequency observation information from a reference GNSS receiver within the region. For each SV, this may be done using a geometry-free measurement to estimate ionosphere STEC using pseudorange and carrier phase multi-frequency measurements. For example, using measurements from L1 and L2 frequency bands, TEC, which may be linked to STEC by a known mapping function, may be determined as follows:

$${TEC}_{{P}_{L 1} - {P}_{L 2}} = \frac{1}{40.308} ( \frac{{f}_{L 1}^{2} {f}_{L 2}^{2}}{{f}_{L 1}^{2} - {f}_{L 2}^{2}} ) ( {P}_{L 2} - {P}_{L 1} ) - {DCB}_{L 1 - L 2} , \qquad ( Eqn . 6 )$$

Where f_{L1} is GPS L1 frequency, f_{L2} is GPS L2 frequency, P_{L1} is GPS L1 PR, P_{L12} is GPS L2 PR, and DCB_{L1-L2} is the differential code bias between L1 and L2. Although DCB may not be known from the measurement information, it can be retrieved from SSR3 in the initial SSR. Thus, Eqn. 6 quickly enables the determination of SSR5 for a geographical region for each SV, using a multi-frequency geometry-free measurement of the SV from a reference GNSS receiver in the region, along with SSR3 data. (It can be noted that, without SSR3 information, DCB still may be determinable from multi-frequency measurements using traditional techniques for DCB determination but may take a long period of time relative to using SSR3.) Some embodiments may further employ TEC smoothing to help reduce noise of TEC values. Additional information is provided below, in reference to FIG. 5.

FIG. 5 illustrates how values for PR STEC maybe smoothed using CP TEC. according to some embodiments. In FIG. 5, a graph 500 illustrates how pseudorange (PR) TEC 510 can be relatively noisy over time for a given satellite having elevation 520. However, by using low pass filtering techniques (e.g., least-square fitting) to fit PR TEC 510 to carrier phase (CP) TEC 530 (which otherwise would have an unknown TEC offset if the ambiguity term N is unknown), noise can be removed from PR TEC 510. The resulting TEC (CP TEC 530 in graph 500) can be used for SSR5.

With respect to SSR6 (tropospheric delay), it can be calculated by leveraging always determined in SSR5 (STEC/ionospheric delay). Tropospheric, or “tropo,” delay is frequency-independent in PR and CP. Similar to ionospheric errors, slant tropo delay from different GNSS SVs are spatially correlated. (The same vertical tropo delay can be mapped to different SV.) With the estimated STEC (SSR5) (e.g., as determined in the manner described above), and with precise satellite orbit (SSR1), satellite clock (SSR2), and DCB (SSR3), tropo delay (SSR6) may be estimated from the PR measurement residual estimated for each SV. This can be done by solving for the tropo term in the pseudorange measurement equation, as follows:

$${PR}^{s} = \vert {\vec{r}}^{s} - {\vec{r}}_{r} \vert + c [ d {t}_{r} - d {T}_{b}^{s} ] + {I}^{s} + {T}^{s} + δ {b}_{Pr}^{s} + {dPR}^{s} + {ϵ}_{PR} , \qquad ( Eqn . 7 )$$

$${T}^{s} = - \vert {\vec{r}}^{s} - {\vec{r}}_{r} \vert - c [ {dt}_{r} - {dT}_{b}^{s} ] - {I}^{s} - δ {b}_{Pr}^{s} - DCB - P {R}^{s} , \qquad ( Eqn . 8 )$$

where Eqn. 8 solves for tropo delay (T^{s}), using the PR measurement (Eqn. 7, corresponding to Eqn. 1). In these equations, the term I^{s} corresponds to SSR5, and terms \vec{r}^{s}, dT_{b}^{s}(t^{s}), and δb_{Pr}^{s} are computable from the initial SSR (SSR1-SSR3). As previously indicated, the term ϵPR is negligible. To solve for T^{s}, the term dtᵣ, which may be unknown, may be computed from two measurements (e.g., of a satellite for two successive time epochs).

It can be noted that methods that would simply estimate and generate regional iono and/or tropo independently, then combine these generated error corrections with open-source PPP products into a SSR package may not give ideal overall correction performance. This is because the open-source PPP products in this case would not couple with the independently-generated regional iono and/or tropo. On the other hand, the methods described herein above, which use the open-source PPP products to generate regional iono and/or tropo enable the coupling feature between SSR corrections, and therefore may be combined into an SSR package with better correction performance.

SSR4 can be determined from the FCB term in the CP measurement equation. That is, with tropospheric (T^{s}) and ionospheric (I^{s}) terms determined (e.g., as shown above), the FCB term can be sold as follows:

$${CP}^{s} = \vert {\vec{r}}^{s} - {\vec{r}}_{r} \vert \text{} + c [ d {t}_{r} ( {t}_{r} ) - d {T}_{b}^{s} ( {t}^{s} ) ] - {I}^{s} + {T}^{s} + {FCB}^{s} + {dCP}^{s} + λ \cdot {N}^{s} + {ϵ}_{C P} , \qquad ( Eqn . 9 )$$

$${FCB}^{s} = - \vert {\vec{r}}^{s} - {\vec{r}}_{r} \vert - c [ d {t}_{r} ( {t}_{r} ) - d {T}_{b}^{s} ( {t}^{s} ) ] + {I}^{s} - {T}^{s} - {CP}^{s} - {dCP}^{s} , \qquad ( Eqn . 10 )$$

where Eqn. 9 corresponds with the CP measurement equation Eqn. 2, and Eqn. 10 solves for the FCB^{s} term in Eqn. 9, driving terms N^{s} and δ_{CP} (which are, as previously noted in Table 1, negligible). FCB may be used as SSR4, the phase bias for CP measurements.

Using the techniques described thus far, an expanded set of SSR 1-SSR 6 can be determined, and (optionally) sent to one or more GNSS receivers in an applicable geographical region. More specifically, SSR1-SSR3 may be publicly available, and SSR4-SSR6 may be determined using the techniques described above. Techniques for determining an expanded set of SSR data can include determining a complete set of SSR data (SSR1-SSR8), by determining SSR7 and SSR8. This can be done quite easily with the other SSR data and may be done using the techniques described below.

With respect to SSR7 (URA), it is essentially a lump sum of all estimated SSR uncertainty. As such, it can be computed as follows:

$${URA}^{s} = {ϵ}_{orbit} + {ϵ}_{c l o c k} + {ϵ}_{code\_bias} + {ϵ}_{phase\_bias} + {ϵ}_{i o n o} + {ϵ}_{tropo} , \qquad ( Eqn . 11 )$$

where orbit, clock, and code bias uncertainty can be estimated empirically using statistics of history data, and ionospheric, tropospheric, and phase bias estimation (co)variances yield their respective uncertainties.

With respect to SSR8, a comprises an array of correction points for a defined region, which can be provided in a straightforward manner. The number and resolution of correction points to offer are the defined region may correspond to a number of reference GNSS receivers in the region. A higher number of reference GNSS receivers, for example, can result in a higher number of correction points, allowing for greater resolution for SSR data interpolated by a receiving device (e.g., target GNSS receiver).

A summary of the computable terms, estimated terms, and output SSR provided by the techniques described above may be summarized as indicated in Table 2:

TABLE 2

| | |
|---|---|
| Computable from | r \vec{ }\hat{ }s, dT_b\hat{ }s (t\hat{ }s ), δb_Pr\hat{ }s |
| public SSR data | |
| Estimated terms | I^{s}, T^{s}, FCB^{s} |
| Output SSR data | phase bias, STEC, gridded/tropo correction, URA |

As noted, SSR data can involve far less traffic (needed communicated between devices) than OSR. As such, inverting measurement data to SSR format in the manner described herein and resulted in error correction that may be far more efficient in terms of communication (e.g., wireless communication resources). As example, or a scenario having 2 constellations, with 10 satellites per constellation, 4 signals per constellation, and 4 OSR observables (pseudorange, carrier phase, Doppler, and CN0), OSR and SSR traffic may be summarized as indicated in Table 3 below, where 7 SSR data elements are transferred every epoch (SSR8 may only be needed once, initially), and the traffic interval for OSR is every second, whereas the traffic interval for SSR is 10 seconds:

TABLE 3

| | OSR | SSR |
|---|---|---|
| # measurement | 2 * 10 * 4 * 4 = 320 | 2 * 10 * (5 + 2 * 4) = 260 |
| count per epoch | | |
| # measurement | 320 * 60 = 19200 | 260 * (60/10) = 1560 |
| count per minute | | |

Here, the measurement count per epoch for OSR is simply a multiplication of constellations, satellites per constellation, signals per constellation, and observables, totaling 320. Because OSR provides these measurements every second (epoch), the total number of measurements per minute is 320*60=19,200. On the other hand, SSR data can remain valid for longer periods of time, allowing for less frequent updates. For example, for some applications, the validity of clock (SSR2) and URA (SSR7) may last 10 seconds, the validity of ionosphere (SSR5) and troposphere (SSR6) data may last 30 seconds, the validity of orbital (SSR1) data may last 60 seconds, and the validity of code bias (SS3) and phase bias (SSR4) may last 10 minutes. Further, rather than 4 observables per signal (4*4), SSR has 5 data elements that are frequency independent (SSR1, SSR2, SSR5, SSR6, and SSR7) and 2 data elements (SSR3 and SSR4) that are signal dependent, resulting in (5+2*4). This reduces the number of measurements per epoch from 320 for OSR to 260 for SSR. Expanding this to every minute, OSR is updated every second (60 times) and SSR is updated every 10 seconds (6 times) resulting in 19,200 measurements for OSR and 1,560 measurements for SSR. And even taking into a count the three separate components of SSR1 (radial, along-track, and cross-track components) which would increase SSR data by a factor of 3 (to 4,680), the total SSR data is still less than a quarter of that required for OSR (4,680/19,200=24.4%).

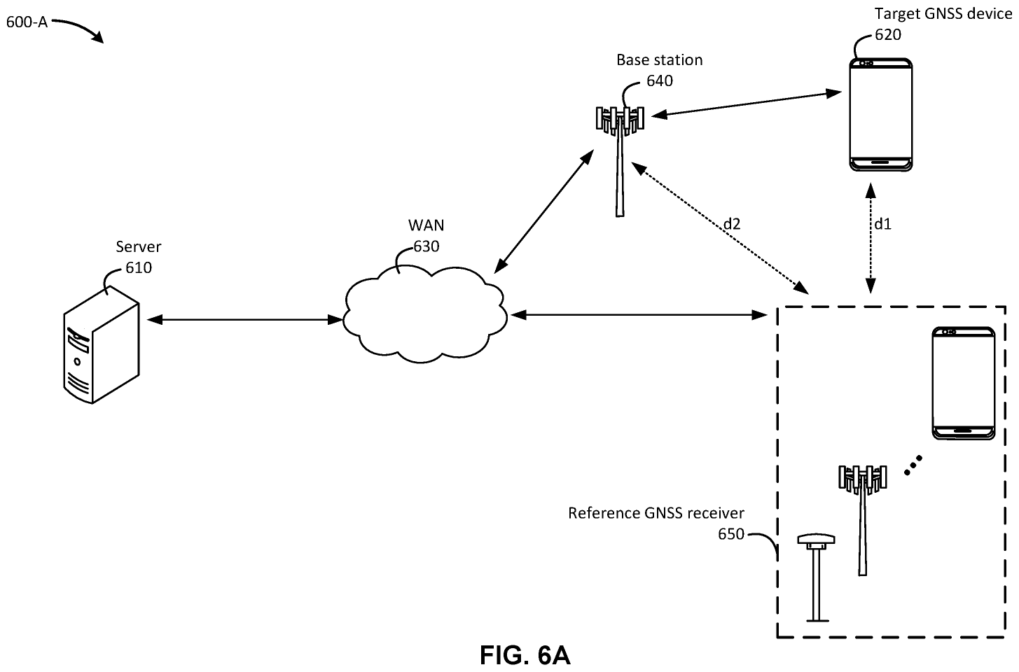

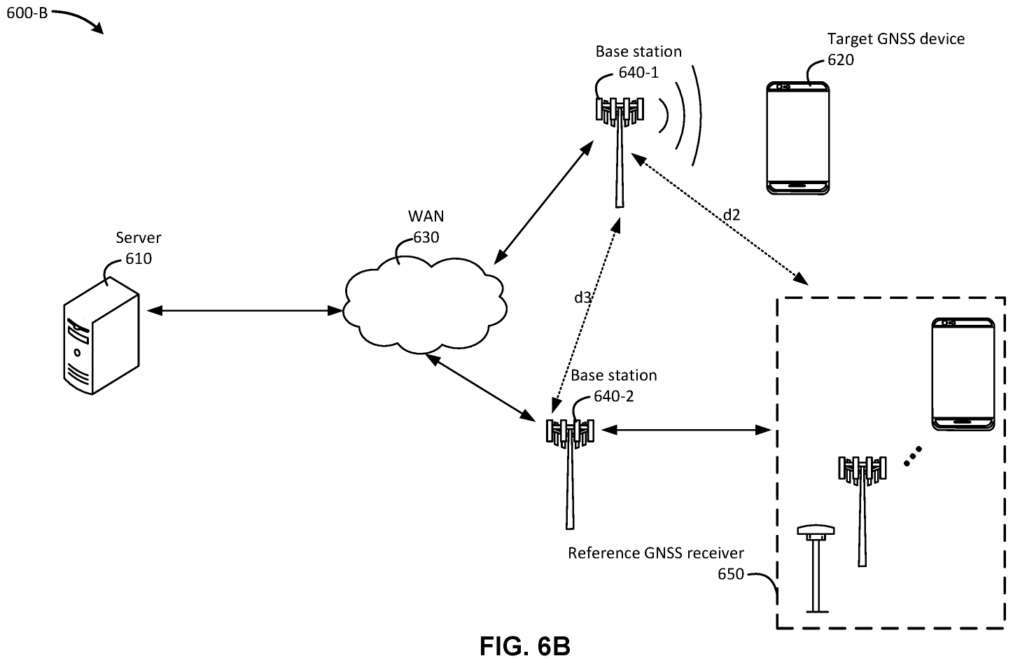

The determination of expanded SSR data based on initial SSR information and measurements from a reference GNSS receiver, as described above, may be implemented in any of a variety of ways. FIGS. 6A and 6B show two such examples.

FIG. 6A is a diagram of a first scenario 600-A, illustrating a way in which expanded SSR data may be determined and propagated, according to an embodiment. This scenario 600-A shows an environment in which a server 610 can provide expanded SSR data to a target GNSS device 620, enabling the target GNSS device 620 to perform high-precision positioning (e.g., PPP and/or RTK) using the SSR data for error correction. Solid arrows illustrate communication links between the various components illustrated. In this example, the target GNSS device 620 comprises a mobile device communicatively coupled with the server 610 via wide area network (WAN) 630, which may comprise one or more public and/or private networks, including the Internet and/or a wireless communication network. The target GNSS device 620 may access the WAN 630 via a base station 640.

In this scenario 600-A, the server 610 may be capable of providing on-demand expanded SSR data in response to a request from the target GNSS device 620. To provide on-demand expanded SSR data, the server 610 may determine an approximate location of the target GNSS device 620, to be able to identify a reference GNSS receiver of 650 from which to obtain the GNSS measurements for expanded SSR determination. The approximate location of the target GNSS device 620 may be obtained in any of a variety of ways, including provided by the device itself, by the base station 640, or determined by the server 610, based on the known location and/or coverage region of the base station 640. This can help ensure that the target GNSS devices of approximately within a threshold distance of the reference GNSS receiver 650 (e.g., as shown by arrow d1), or at least the base station 640 is within a threshold distance of the reference GNSS receiver 650 (e.g., as shown by arrow d2), thereby helping ensure the expanded SSR data based on measurements from the reference GNSS receiver 650 is applicable to the geographical region in which the target GNSS device 620 is located.

As illustrated in FIG. 6A, the reference GNSS receiver 650 may comprise any of a variety of device types. This can include, for example, another mobile device, a base station, a dedicated GNSS receiver, a survey GNSS receiver, and/or any other GNSS receiver having a known (e.g., high-precision) position. The reference GNSS receiver 650 may be communicatively coupled to the server 610 (e.g., via the WAN 630, as shown) using one or more wired and/or wireless networks, for example, which may depend on the type of device of the reference GNSS receiver 650. Once the server 610 identifies the reference GNSS receiver 650 (e.g., in response to a request for expanded SSR data from the target GNSS device 620) the server 610 can request measurement data from the reference GNSS receiver 650

As for the publicly-available initial SSR data, the server 610 may obtain it through a known available public source. Alternatively, the server 610 may obtain it from the base station 640, reference GNSS receiver 650, or even the target GNSS device 620 itself, any of which may obtain the initial SSR data via a public source and/or broadcast.

With the measurements from the reference GNSS receiver 650 and the initial SSR data, the server 610 may then determine one or more elements of the expanded SSR data, as described herein above, and provide it to the target GNSS device 620. According to some embodiments, it may continue to provide expanded SSR data (e.g., every 10 seconds) until a certain expiration point, such as when request of the target GNSS device 620 expires, when the server 610 receives a second request from the target GNSS device 620 to stop sending the expanded SSR data, or another such trigger or scheduled event occurs.

FIG. 6B is a diagram of a second scenario 600-B, illustrating another way in which expanded SSR data may be determined and propagated, according to an embodiment. The second scenario 600-B is largely similar to the first scenario 600-A of FIG. 6A previously described. Here, however, expanded SSR data may be broadcast to devices within a geographical region. More specifically, the target GNSS device 620 may obtain expanded SSR data from a broadcast by a first base station 640-1. In this scenario 600-B, the server 610 may generate the expanded SSR data in a manner similar to the process described with respect to FIG. 6A. Here, however, the determination of the reference receiver 650 may not be based on a distance between the reference GNSS receiver 650 and the target GNSS device 620 (which may be unknown to the server 610). Instead, expanded SSR data provided by the server 610 to the first base station 640-1 based on a distance between the first base station 640-1 and the reference GNSS receiver 650 (e.g., shown by arrow d2) or, in cases where the reference GNSS receiver 650 is connected to the WAN 630 via a second base station 640-2 (as illustrated in FIG. 6B), based on a distance between the second base station 640-2 and the first base station 640-1 (e.g., shown by arrow d3).

As a person of ordinary skill in the art will appreciate, other variations to the examples illustrated in FIGS. 6A and 6B may be implemented to determine and/or propagate expanded SSR data. One such variation may include determining the expanded SSR data at the reference GNSS receiver 650 itself, which may provide the expanded SSR data to the server 610 and/or directly to a target GNSS device 620. In another variation, the server 610 may not need to request measurement information from a reference GNSS receiver 650 for a target GNSS device 620 if the reference GNSS receiver 650 is already providing measurement information to the server 610 (e.g., for the determination of expanded SSR data or one or more other target devices in the area (not shown)). Yet other variations are contemplated.

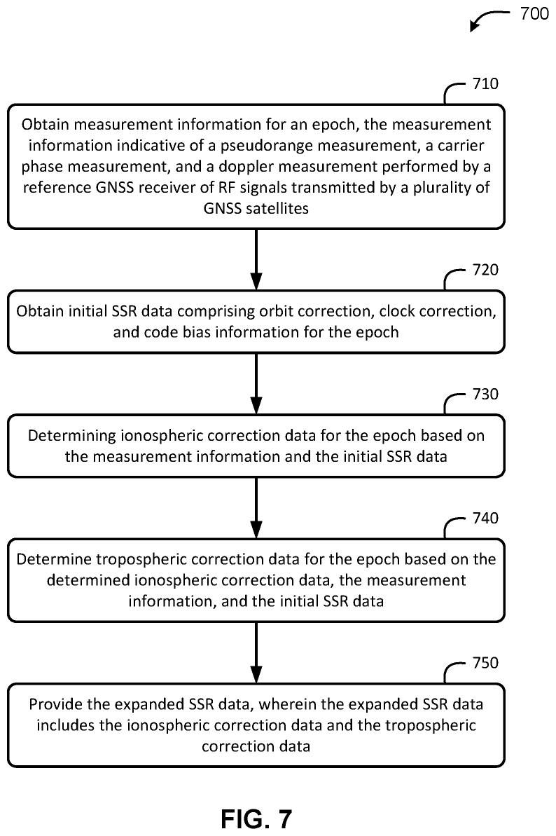

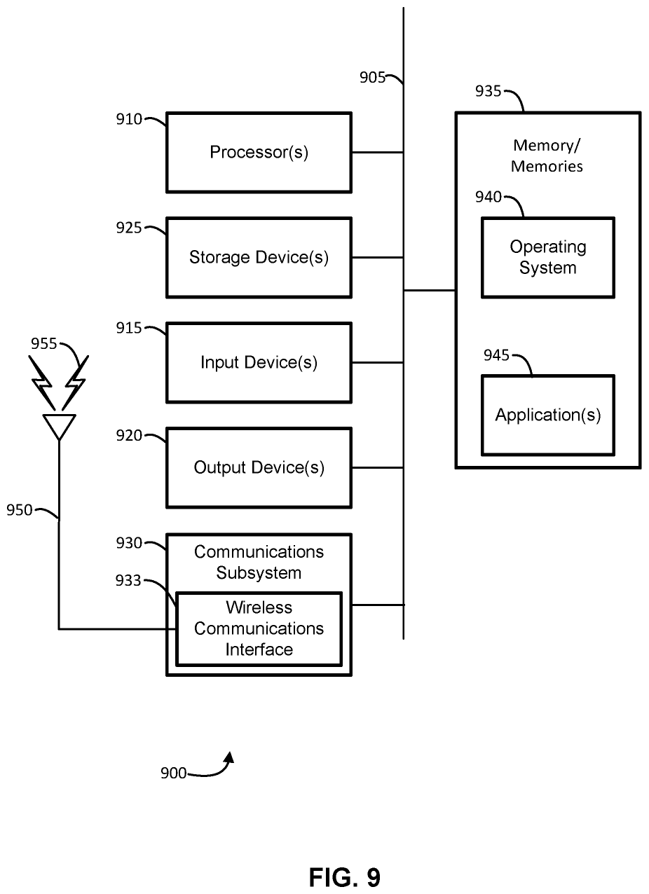

FIG. 7 is a flow diagram illustrating an example method 700 providing expanded SSR data for GNSS-based positioning, according to aspects of the disclosure. As described herein, expanded SSR data may include one or more of SSR4-SSR8, According to aspects of the disclosure, means for performing the functionality illustrated in one or more of the blocks shown in FIG. 7 may be performed by hardware and/or software components of a computer server or GNSS device (the latter of which may comprise a mobile device, base station, or other device comprising and/or communicatively coupled with a GNSS receiver). Example components of a computer system that could operate as a computer server are illustrated in FIG. 9, which is described in more detail below. Example components of a GNSS device are illustrated in FIG. 8, which is described in more detail below.

At block 710, the functionality comprises obtaining measurement information for an epoch, the measurement information indicative of a pseudorange measurement, a carrier phase measurement, and a doppler measurement performed by a reference GNSS receiver of RF signals transmitted by a plurality of GNSS satellites. Such measurements may correspond with Eqns. 1-3 described herein. For embodiments in which a server (e.g., server 610) obtains the measurement information, obtaining the measurement information may comprise receiving the measurement information from the reference GNSS receiver. Such embodiments may further comprise sending a request for the measurement information from the server to the reference GNSS receiver. Optionally, sending the request may be performed in response to receiving a request from a mobile device (e.g., target GNSS device 620) at the server, wherein the request may comprise a request for the expanded SSR data. Additionally or alternatively, for embodiments in which a reference GNSS receiver (e.g., reference GNSS receiver 650) obtains the measurement information, obtaining the measurement information may comprise performing the measurements of the RF signals transmitted by the plurality of GNSS satellites. As noted herein, a reference GNSS receiver may perform the measurements responsive to a request for the measurements and/or expanded SSR data from a server and/or from a target GNSS device.

Means for performing functionality at block 710 may comprise a bus 805, processor(s) 810, digital signal processor (DSP) 820, memory/memories 860, GNSS receiver 880, and/or other components of a GNSS device 800, as illustrated in FIG. 8, for example. Means for performing functionality at block 710 additionally or alternatively may comprise a bus 905, processor(s) 910, communications subsystem 930 (which may include wireless communications interface 933), memory/memories 935, operating system 940, application(s) 945, and/or other components of a computer system 900 as illustrated in FIG. 9, for example.

At block 720, the functionality comprises obtaining initial SSR data comprising orbit correction, clock correction, and code bias information for the epoch. As noted, initial SSR data (SSR1-SSR3) may be obtained for free from services such as IGS SSR, BDS-B2b, and others. Depending on the source, these may be obtained via wireless (e.g., broadcast, unicast, or groupcast) and/or wired communications, which may include the Internet.

Means for performing functionality at block 720 may comprise a bus 805. processor(s) 810, digital signal processor (DSP) 820, memory/memories 860, GNSS receiver 880, and/or other components of a GNSS device 800, as illustrated in FIG. 8, for example. Means for performing functionality at block 720 additionally or alternatively may comprise a bus 905, processor(s) 910, communications subsystem 930 (which may include wireless communications interface 933), memory/memories 935, operating system 940, application(s) 945, and/or other components of a computer system 900 as illustrated in FIG. 9. for example.

At block 730, the functionality comprises determining ionospheric correction data for the epoch based on the measurement information and the initial SSR data, and at block 740, the functionality comprises determining tropospheric correction data for the epoch based on the determined ionospheric correction data, the measurement information, and the initial SSR data. The ionospheric correction data and tropospheric correction data may correspond with SSR5 and SSR6 respectively and may be determined as described herein with respect to Eqns. 6-8. As such, according to some embodiments, determining the ionospheric correction data may comprise estimating an STEC value from the pseudorange measurement and the carrier phase measurement using a geometry-free measurement. According to some embodiments, one or both of the ionospheric correction data are tropospheric correction data may be included in the expanded SSR data.

Some embodiments may include additional SSR data. For example, some embodiments may further comprise determining phase bias data based on the determined ionospheric correction data, the determined tropospheric correction data, the measurement information, and the initial SSR data and including the determined phase bias data in the expanded SSR data. This phase bias data may correspond with SSR4 and may be determined as described herein with respect to Eqns. 9-10. Some embodiments may further comprise determining an SSR uncertainty value associated with the expanded SSR data and including the SSR uncertainty value in the expanded SSR data. This SSR uncertainty value may correspond with SSR8 and may be determined as described herein with respect to Eqns. 11.

Means for performing functionality at blocks 730 and 740 may comprise a bus 805, processor(s) 810, digital signal processor (DSP) 820, memory/memories 860, GNSS receiver 880, and/or other components of a GNSS device 800, as illustrated in FIG. 8, for example. Means for performing functionality at block blocks 730 and 740 additionally or alternatively may comprise a bus 905, processor(s) 910, communications subsystem 930 (which may include wireless communications interface 933), memory/memories 935, operating system 940, application(s) 945, and/or other components of a computer system 900 as illustrated in FIG. 9, for example.

At block 750, the functionality comprises providing the expanded SSR data, wherein the expanded SSR data includes the ionospheric correction data and the tropospheric correction data. As noted, embodiments may differ in which device determines the expanded SSR data, and thus, providing the expanded SSR data may be performed in different ways. According to some embodiments, for example, the expanded SSR data may comprise sending the expanded SSR data to a mobile device. As indicated with respect to FIG. 6A, sending the expanded SSR data to a mobile device, obtaining the measurement information, or both, may be responsive to a request from the mobile device (e.g., target GNSS device 620). Such embodiments may further comprise selecting the reference GNSS receiver from a plurality of candidate reference GNSS receivers (e.g., reference GNSS receivers in different regions) based at least in part on a location of the reference GNSS receiver and a location of the mobile device. In such embodiments, obtaining the measurement information may comprise sending a request for the measurement information to the reference GNSS receiver, and receiving the measurement information from the reference GNSS receiver. Additionally or alternatively, as illustrated in FIG. 6B, sending the expanded SSR data to a mobile device comprises broadcasting the expanded SSR data.

Means for performing functionality at block 750 may comprise a bus 805, processor(s) 810, digital signal processor (DSP) 820, memory/memories 860, GNSS receiver 880, and/or other components of a GNSS device 800, as illustrated in FIG. 8, for example. Means for performing functionality at block 750 additionally or alternatively may comprise a bus 905, processor(s) 910, communications subsystem 930 (which may include wireless communications interface 933), memory/memories 935, operating system 940, application(s) 945, and/or other components of a computer system 900 as illustrated in FIG. 9, for example.

FIG. 8 is a block diagram of an embodiment of a GNSS device 800, which can be utilized as described herein above (e.g., in association with FIGS. 1-7). For example, the GNSS device 800 can be used to implement one or incorporate the GNSS receiver 110 of FIG. 1. PPP-based PPE 200 of FIG. 2, RTK positioning scheme 300 of FIG. 3, target GNSS device 620 and/or reference GNSS receiver 650 of FIGS. 6A and 6B, and the like. In some examples, GNSS device 800 can perform one or more operations associated with the method 700 of FIG. 7. It should be noted that FIG. 8 is meant only to provide a generalized illustration of various components, any or all of which may be utilized as appropriate.

The GNSS device 800 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The GNSS device 800 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The GNSS device 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 800 to communicate with other devices as described in the embodiments above. The wireless communication interface 830 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The GNSS device 800 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 800 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 800 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the GNSS device 800, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS), and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 810 or DSP 820.

The GNSS device 800 may further include and/or be in communication with a memory 860. The memory 860 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the GNSS device 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the GNSS device 800 (and/or processor(s) 810 or DSP 820 within GNSS device 800). In some embodiments, then, such code and/or instructions can be used to configure and/or adapt a general-purpose computer (or other device) to perform one or more operations in accordance with the described methods.

FIG. 9 is a block diagram of an embodiment of a computer system 900, which may be used, in whole or in part, to provide the functions of one or more components and/or devices as described in the embodiments herein, including a server and/or services in the cloud. Thus, the computer system 900 may be utilized as and/or correspond with, for example, a network function server 610 of FIGS. 6A and 6B, and/or a cloud, server, and/or remote device, or any combination thereof, as described herein. The computer system 900 may perform one or more of the operations of method 700 illustrated in FIG. 7. The computer system 900 may include, for example, a computer server, personal computer, personal electronic device, or the like. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computer system 900 is shown comprising hardware elements that can be electrically coupled via a bus 905 (or may otherwise be in communication, as appropriate). The hardware elements may include processor(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 900 also may comprise one or more input devices 915, which may comprise without limitation a mouse, a keyboard, a camera, a microphone, and/or the like; and one or more output devices 920, which may comprise without limitation a display device, a printer, and/or the like.

The computer system 900 may further include (and/or be in communication with) one or more non-transitory storage devices 925, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 900 may also include a communications subsystem 930, which may comprise wireless communication technologies managed and controlled by a wireless communication interface 933, as well as wired technologies (such as Ethernet, coaxial communications, universal serial bus (USB), and the like). The wireless communication interface 933 may comprise one or more wireless transceivers that may send and receive wireless signals 955 (e.g., signals according to 5G NR or LTE) via wireless antenna(s) 950. Thus the communications subsystem 930 may comprise a modem, a network card (wireless or wired), an infrared communication device, a wireless communication device, and/or a chipset, and/or the like, which may enable the computer system 900 to communicate on any or all of the communication networks described herein to any device on the respective network, including a User Equipment (UE), base stations and/or other transmission reception points (TRPs), and/or any other electronic devices described herein. Hence, the communications subsystem 930 may be used to receive and send data as described in the embodiments herein.

In many embodiments, the computer system 900 will further comprise a working memory 935, which may comprise a RAM or ROM device, as described above. Software elements, shown as being located within the working memory 935, may comprise an operating system 940, device drivers, executable libraries, and/or other code, such as one or more applications 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general-purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C. here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1: A method of providing expanded state-space representation (SSR) data for global navigation satellite system (GNSS)-based positioning, the method comprising: obtaining measurement information for an epoch, the measurement information indicative of a pseudorange measurement, a carrier phase measurement, and a doppler measurement performed by a reference GNSS receiver of radio frequency (RF) signals transmitted by a plurality of GNSS satellites; obtaining initial SSR data comprising orbit correction, clock correction, and code bias information for the epoch; determining ionospheric correction data for the epoch based on the measurement information and the initial SSR data; determining tropospheric correction data for the epoch based on the determined ionospheric correction data, the measurement information, and the initial SSR data; and providing the expanded SSR data, wherein the expanded SSR data includes the ionospheric correction data and the tropospheric correction data.
Clause 2: The method of clause 1, further comprising: determining phase bias data based on the determined ionospheric correction data, the determined tropospheric correction data, the measurement information, and the initial SSR data; and including the determined phase bias data in the expanded SSR data.
Clause 3: The method of any one of clauses 1-2 further comprising determining an SSR uncertainty value associated with the expanded SSR data; and including the SSR uncertainty value in the expanded SSR data.
Clause 4: The method of any one of clauses 1-3 determining the ionospheric correction data comprises estimating a slant total electron content (STEC) value from the pseudorange measurement and the carrier phase measurement using a geometry-free measurement.
Clause 5: The method of any one of clauses 1-4 wherein providing the expanded SSR data comprises sending the expanded SSR data to a mobile device.
Clause 6: The method of clause 5 wherein sending the expanded SSR data to a mobile device, obtaining the measurement information, or both, is responsive to a request from the mobile device.
Clause 7: The method of any one of clauses 5-6 further comprising selecting the reference GNSS receiver from a plurality of candidate reference GNSS receivers based at least in part on a location of the reference GNSS receiver and a location of the mobile device; and wherein obtaining the measurement information comprises: sending a request for the measurement information to the reference GNSS receiver; and receiving the measurement information from the reference GNSS receiver.
Clause 8: The method of clause 5 wherein sending the expanded SSR data to a mobile device comprises broadcasting the expanded SSR data.
Clause 9: A device for providing expanded state-space representation (SSR) data for global navigation satellite system (GNSS)-based positioning, the device comprising: one or more transceivers; one or more memories; and one or more processors communicatively coupled with the one or more transceivers and the one or more memories, wherein the one or more processors are configured to: obtain measurement information for an epoch, the measurement information indicative of a pseudorange measurement, a carrier phase measurement, and a doppler measurement performed by a reference GNSS receiver of radio frequency (RF) signals transmitted by a plurality of GNSS satellites; obtain initial SSR data comprising orbit correction, clock correction, and code bias information for the epoch; determine ionospheric correction data for the epoch based on the measurement information and the initial SSR data; determine tropospheric correction data for the epoch based on the determined ionospheric correction data, the measurement information, and the initial SSR data; and provide the expanded SSR data, wherein the expanded SSR data includes the ionospheric correction data and the tropospheric correction data.
Clause 10: The device of clause 9, wherein the one or more processors are further configured to: determine phase bias data based on the determined ionospheric correction data, the determined tropospheric correction data, the measurement information, and the initial SSR data; and include the determined phase bias data in the expanded SSR data.
Clause 11: The device of any one of clauses 9-10 wherein the one or more processors are further configured to: determine an SSR uncertainty value associated with the expanded SSR data; and include the SSR uncertainty value in the expanded SSR data.
Clause 12: The device of any one of clauses 9-11 wherein, to determine the ionospheric correction data, the one or more processors are configured to estimate a slant total electron content (STEC) value from the pseudorange measurement and the carrier phase measurement using a geometry-free measurement.
Clause 13: The device of any one of clauses 9-12 wherein, to provide the expanded SSR data, the one or more processors are configured to send, via the one or more transceivers, the expanded SSR data to a mobile device.
Clause 14: The device of clause 13 wherein the one or more processors are configured to send the expanded SSR data to a mobile device, obtain the measurement information, or both, responsive to a request from the mobile device.
Clause 15: The device of any one of clauses 13-14 wherein the one or more processors are further configured to select the reference GNSS receiver from a plurality of candidate reference GNSS receivers based at least in part on a location of the reference GNSS receiver and a location of the mobile device; and wherein, to obtain the measurement information, the one or more processors are configured to: send, via the one or more transceivers, a request for the measurement information to the reference GNSS receiver; and receive, via the one or more transceivers, the measurement information from the reference GNSS receiver.
Clause 16: The device of clause 13 wherein, to send the expanded SSR data to a mobile device, the one or more processors are configured to broadcast the expanded SSR data, via the one or more transceivers.
Clause 17: An apparatus for providing expanded state-space representation (SSR) data for global navigation satellite system (GNSS)-based positioning, the apparatus comprising: means for obtaining measurement information for an epoch, the measurement information indicative of a pseudorange measurement, a carrier phase measurement, and a doppler measurement performed by a reference GNSS receiver of radio frequency (RF) signals transmitted by a plurality of GNSS satellites; means for obtaining initial SSR data comprising orbit correction, clock correction, and code bias information for the epoch; means for determining ionospheric correction data for the epoch based on the measurement information and the initial SSR data; means for determining tropospheric correction data for the epoch based on the determined ionospheric correction data, the measurement information, and the initial SSR data; and means for providing the expanded SSR data, wherein the expanded SSR data includes the ionospheric correction data and the tropospheric correction data.
Clause 18: The apparatus of clause 17, further comprising: means for determining phase bias data based on the determined ionospheric correction data, the determined tropospheric correction data, the measurement information, and the initial SSR data; and means for including the determined phase bias data in the expanded SSR data.
Clause 19: The apparatus of any one of clauses 17-18 further comprising means for determining an SSR uncertainty value associated with the expanded SSR data; and means for including the SSR uncertainty value in the expanded SSR data.
Clause 20: The apparatus of any one of clauses 17-19 the means for determining the ionospheric correction data comprises means for estimating a slant total electron content (STEC) value from the pseudorange measurement and the carrier phase measurement using a geometry-free measurement.
Clause 21: The apparatus of any one of clauses 17-20 wherein the means for providing the expanded SSR data comprises means for sending the expanded SSR data to a mobile device.
Clause 22: The apparatus of clause 21 further comprising means for selecting the reference GNSS receiver from a plurality of candidate reference GNSS receivers based at least in part on a location of the reference GNSS receiver and a location of the mobile device; and wherein the means for obtaining the measurement information comprises: means for sending a request for the measurement information to the reference GNSS receiver; and means for receiving the measurement information from the reference GNSS receiver.
Clause 23: The apparatus of clause 21 wherein the means for sending the expanded SSR data to a mobile device comprises means for broadcasting the expanded SSR data.
Clause 24: A non-transitory computer-readable medium storing instructions for providing expanded state-space representation (SSR) data for global navigation satellite system (GNSS)-based positioning, the instructions comprising code for: obtaining measurement information for an epoch, the measurement information indicative of a pseudorange measurement, a carrier phase measurement, and a doppler measurement performed by a reference GNSS receiver of radio frequency (RF) signals transmitted by a plurality of GNSS satellites; obtaining initial SSR data comprising orbit correction, clock correction, and code bias information for the epoch; determining ionospheric correction data for the epoch based on the measurement information and the initial SSR data; determining tropospheric correction data for the epoch based on the determined ionospheric correction data, the measurement information, and the initial SSR data; and providing the expanded SSR data, wherein the expanded SSR data includes the ionospheric correction data and the tropospheric correction data.
Clause 25: The computer-readable medium of clause 24, wherein the instructions further comprise code for: determining phase bias data based on the determined ionospheric correction data, the determined tropospheric correction data, the measurement information, and the initial SSR data; and including the determined phase bias data in the expanded SSR data.
Clause 26: The computer-readable medium of any one of clauses 24-25 wherein the instructions further comprise code for: determining an SSR uncertainty value associated with the expanded SSR data; and including the SSR uncertainty value in the expanded SSR data.
Clause 27: The computer-readable medium of any one of clauses 24-26 wherein the code for determining the ionospheric correction data comprises code for estimating a slant total electron content (STEC) value from the pseudorange measurement and the carrier phase measurement using a geometry-free measurement.
Clause 28: The computer-readable medium of any one of clauses 24-27 wherein the code for providing the expanded SSR data comprises code for sending the expanded SSR data to a mobile device.
Clause 29: The computer-readable medium of clause 28 wherein the instructions further comprise code for selecting the reference GNSS receiver from a plurality of candidate reference GNSS receivers based at least in part on a location of the reference GNSS receiver and a location of the mobile device; and wherein the code for obtaining the measurement information comprises code for: sending a request for the measurement information to the reference GNSS receiver; and receiving the measurement information from the reference GNSS receiver.
Clause 30: The computer-readable medium of clause 28 wherein the code for sending the expanded SSR data to a mobile device comprises code for broadcasting the expanded SSR data.

What is claimed is:

1. A method of providing expanded state-space representation (SSR) data for global navigation satellite system (GNSS)-based positioning, the method comprising:
obtaining measurement information for an epoch, the measurement information indicative of a pseudorange measurement, a carrier phase measurement, and a doppler measurement performed by a reference GNSS receiver of radio frequency (RF) signals transmitted by a plurality of GNSS satellites;
obtaining initial SSR data comprising orbit correction, clock correction, and code bias information for the epoch;
determining ionospheric correction data for the epoch based on the measurement information and the initial SSR data;
determining tropospheric correction data for the epoch based on the determined ionospheric correction data, the measurement information, and the initial SSR data; and
providing the expanded SSR data, wherein the expanded SSR data includes the ionospheric correction data and the tropospheric correction data.

2. The method of claim 1, further comprising:
determining phase bias data based on the determined ionospheric correction data, the determined tropospheric correction data, the measurement information, and the initial SSR data; and
including the determined phase bias data in the expanded SSR data.

3. The method of claim 1, further comprising:
determining an SSR uncertainty value associated with the expanded SSR data; and
including the SSR uncertainty value in the expanded SSR data.

4. The method of claim 1, determining the ionospheric correction data comprises estimating a slant total electron content (STEC) value from the pseudorange measurement and the carrier phase measurement using a geometry-free measurement.

5. The method of claim 1, wherein providing the expanded SSR data comprises sending the expanded SSR data to a mobile device.

6. The method of claim 5, wherein sending the expanded SSR data to a mobile device, obtaining the measurement information, or both, is responsive to a request from the mobile device.

7. The method of claim 5, further comprising selecting the reference GNSS receiver from a plurality of candidate reference GNSS receivers based at least in part on a location of the reference GNSS receiver and a location of the mobile device; and wherein obtaining the measurement information comprises:
sending a request for the measurement information to the reference GNSS receiver; and
receiving the measurement information from the reference GNSS receiver.

8. The method of claim 5, wherein sending the expanded SSR data to a mobile device comprises broadcasting the expanded SSR data.

9. A device for providing expanded state-space representation (SSR) data for global navigation satellite system (GNSS)-based positioning, the device comprising:
one or more transceivers;
one or more memories; and
one or more processors communicatively coupled with the one or more transceivers and the one or more memories, wherein the one or more processors are configured to:
obtain measurement information for an epoch, the measurement information indicative of a pseudorange measurement, a carrier phase measurement, and a doppler measurement performed by a reference GNSS receiver of radio frequency (RF) signals transmitted by a plurality of GNSS satellites;
obtain initial SSR data comprising orbit correction, clock correction, and code bias information for the epoch;
determine ionospheric correction data for the epoch based on the measurement information and the initial SSR data;
determine tropospheric correction data for the epoch based on the determined ionospheric correction data, the measurement information, and the initial SSR data; and
provide the expanded SSR data, wherein the expanded SSR data includes the ionospheric correction data and the tropospheric correction data.

10. The device of claim 9, wherein the one or more processors are further configured to:
determine phase bias data based on the determined ionospheric correction data, the determined tropospheric correction data, the measurement information, and the initial SSR data; and
include the determined phase bias data in the expanded SSR data.

11. The device of claim 9, wherein the one or more processors are further configured to:
determine an SSR uncertainty value associated with the expanded SSR data; and
include the SSR uncertainty value in the expanded SSR data.

12. The device of claim 9, wherein, to determine the ionospheric correction data, the one or more processors are configured to estimate a slant total electron content (STEC) value from the pseudorange measurement and the carrier phase measurement using a geometry-free measurement.

13. The device of claim 9, wherein, to provide the expanded SSR data, the one or more processors are configured to send, via the one or more transceivers, the expanded SSR data to a mobile device.

14. The device of claim 13, wherein the one or more processors are configured to send the expanded SSR data to a mobile device, obtain the measurement information, or both, responsive to a request from the mobile device.

15. The device of claim 13, wherein the one or more processors are further configured to select the reference GNSS receiver from a plurality of candidate reference GNSS receivers based at least in part on a location of the reference GNSS receiver and a location of the mobile device; and wherein, to obtain the measurement information, the one or more processors are configured to:
send, via the one or more transceivers, a request for the measurement information to the reference GNSS receiver; and
receive, via the one or more transceivers, the measurement information from the reference GNSS receiver.

16. The device of claim 13, wherein, to send the expanded SSR data to a mobile device, the one or more processors are configured to broadcast the expanded SSR data, via the one or more transceivers.

17. An apparatus for providing expanded state-space representation (SSR) data for global navigation satellite system (GNSS)-based positioning, the apparatus comprising:
means for obtaining measurement information for an epoch, the measurement information indicative of a pseudorange measurement, a carrier phase measurement, and a doppler measurement performed by a reference GNSS receiver of radio frequency (RF) signals transmitted by a plurality of GNSS satellites;
means for obtaining initial SSR data comprising orbit correction, clock correction, and code bias information for the epoch;
means for determining ionospheric correction data for the epoch based on the measurement information and the initial SSR data;
means for determining tropospheric correction data for the epoch based on the determined ionospheric correction data, the measurement information, and the initial SSR data; and
means for providing the expanded SSR data, wherein the expanded SSR data includes the ionospheric correction data and the tropospheric correction data.

18. The apparatus of claim 17, further comprising:
means for determining phase bias data based on the determined ionospheric correction data, the determined tropospheric correction data, the measurement information, and the initial SSR data; and
means for including the determined phase bias data in the expanded SSR data.

19. The apparatus of claim 17, further comprising:
means for determining an SSR uncertainty value associated with the expanded SSR data; and
means for including the SSR uncertainty value in the expanded SSR data.

20. The apparatus of claim 17, the means for determining the ionospheric correction data comprises means for estimating a slant total electron content (STEC) value from the pseudorange measurement and the carrier phase measurement using a geometry-free measurement.

21. The apparatus of claim 17, wherein the means for providing the expanded SSR data comprises means for sending the expanded SSR data to a mobile device.

22. The apparatus of claim 21, further comprising means for selecting the reference GNSS receiver from a plurality of candidate reference GNSS receivers based at least in part on a location of the reference GNSS receiver and a location of the mobile device; and wherein the means for obtaining the measurement information comprises:
means for sending a request for the measurement information to the reference GNSS receiver; and
means for receiving the measurement information from the reference GNSS receiver.

23. The apparatus of claim 21, wherein the means for sending the expanded SSR data to a mobile device comprises means for broadcasting the expanded SSR data.

24. A non-transitory computer-readable medium storing instructions for providing expanded state-space representation (SSR) data for global navigation satellite system (GNSS)-based positioning, the instructions comprising code for:
obtaining measurement information for an epoch, the measurement information indicative of a pseudorange measurement, a carrier phase measurement, and a doppler measurement performed by a reference GNSS receiver of radio frequency (RF) signals transmitted by a plurality of GNSS satellites;
obtaining initial SSR data comprising orbit correction, clock correction, and code bias information for the epoch;
determining ionospheric correction data for the epoch based on the measurement information and the initial SSR data;
determining tropospheric correction data for the epoch based on the determined ionospheric correction data, the measurement information, and the initial SSR data; and
providing the expanded SSR data, wherein the expanded SSR data includes the ionospheric correction data and the tropospheric correction data.

25. The computer-readable medium of claim 24, wherein the instructions further comprise code for:
determining phase bias data based on the determined ionospheric correction data, the determined tropospheric correction data, the measurement information, and the initial SSR data; and
including the determined phase bias data in the expanded SSR data.

26. The computer-readable medium of claim 24, wherein the instructions further comprise code for:
determining an SSR uncertainty value associated with the expanded SSR data; and
including the SSR uncertainty value in the expanded SSR data.

27. The computer-readable medium of claim 24, wherein the code for determining the ionospheric correction data comprises code for estimating a slant total electron content (STEC) value from the pseudorange measurement and the carrier phase measurement using a geometry-free measurement.

28. The computer-readable medium of claim 24, wherein the code for providing the expanded SSR data comprises code for sending the expanded SSR data to a mobile device.

29. The computer-readable medium of claim 28, wherein the instructions further comprise code for selecting the reference GNSS receiver from a plurality of candidate reference GNSS receivers based at least in part on a location of the reference GNSS receiver and a location of the mobile device; and wherein the code for obtaining the measurement information comprises code for:
sending a request for the measurement information to the reference GNSS receiver; and
receiving the measurement information from the reference GNSS receiver.

30. The computer-readable medium of claim 28, wherein the code for sending the expanded SSR data to a mobile device comprises code for broadcasting the expanded SSR data.
